(19) United States
(12) Patent Application Publication
(10) Pub. No.: US 2007/0245281 A1
(43) Pub. Date: Oct. 18, 2007

(54) Placement-Driven Physical-Hierarchy Generation

(76) Inventors: Michael A. Riepe, San Jose, CA (US); Niranjana Balasundaram, Newark, CA (US); Menno Ewout Verbeek, JIM Utrecht (NL); Hong Cai, Redwood City, CA (US); Roger Carpenter, Palo Alto, CA (US); Jacob Avidan, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/734,757

(22) Filed: Apr. 12, 2007

Related U.S. Application Data
(60) Provisional application No. 60/791,980, filed on Apr. 14, 2006.

(51) Int. Cl. G06F 17/50; G06F 9/45

(52) U.S. Cl. 716/9; 716/7

(57) ABSTRACT

A method and system for performing placement-driven physical hierarchy generation in the context of an integrated circuit layout generation system is provided. This generation optimizes the physical hierarchy to improve placement of the cells in the layout, and the associated interconnect routability and delay. A new pre-clustering phase is introduced to maintain as much of the input logical hierarchy as possible while maintaining physical hierarchy quality. And a new cost function is described which is based on measuring the mutual affinity of cells in a virtually-flat placement. The new cost function is used during the new pre-clustering phase, as well as the common clustering, partitioning, and declustering/refinement phases of physical hierarchy generation.

### CROSS REFERENCE TO RELATED APPLICATIONS

This application claims a benefit, and priority, under 35 USC §119(e) to U.S. Provisional Patent Application No. 60/791,980, titled “Placement-Driven Physical-Hierarchy Generation”, filed Apr. 14, 2006, the contents of which are herein incorporated by reference.

### BACKGROUND

1. Field of the Art

The disclosure herein relates generally to the field of integrated circuit design and more specifically to the automated layout design of semiconductor chips.

2. Description of the Related Art

In an Electronic Design Automation (EDA) system for hierarchical integrated circuit (IC) design, the Physical Hierarchy Generation (PHG) step is responsible for partitioning the input netlist into a set of two or more hierarchical modules which can be referred to as soft macros. The PHG problem is the first step in any top-down hierarchical design planning system, and therefore, all proceeding steps depend of the quality of the PHG solution.

In general, large integrated circuits are often designed hierarchically, as opposed to the alternative flat design flow. There are several reasons for this including enabling (1) a “divide and conquer” approach for design teams to manage size and complexity; (2) a distributed design, in which self-contained pieces of a design are given to multiple engineering teams to be designed in parallel; (3) a convenient reuse of soft macros that may be used again in a different design, or repeated multiple times in the same design; and (4) EDA tools, which have a finite capacity based on available memory and runtime, to operate on manageable sized pieces of the design.

In an EDA physical design system, however, hierarchy introduces an extra level of complexity over flat design. For example, soft macros must be floorplanned, i.e., each must be assigned a shape and then placed such that it is not overlapping the other soft and hard macros. Leaf cells (standard cells and hard macros) are constrained to be placed within those artificial boundaries, possibly causing them to be moved from their optimal “flat” locations, increasing signal delay. Signal routes between soft macros are similarly constrained to cross the soft macro boundaries only at pre-defined pin locations, which may also cause the routes to deviate from their optimal shortest paths. Register-to-register paths that cross the boundaries must be budgeted such that the arrival times at the soft macro boundaries are fixed; incorrect budgets may lead to unsolvable interconnect optimization problems.

Hierarchical design planning choices can have a large impact on the quality of a design's interconnect performance. Increased signal delays, especially on large global signals between soft macros, can result from increased net lengths or increased routing congestion if floorplanning, pin assignment, or budgeting quality are poor. Increases in net length and/or congestion also can result in increased signal integrity issues, for example, crosstalk delay and noise violations, I-R drop violations, and ringing due to inductance effects. Increased wiring densities can lead to manufacturability problems due to higher defect rates and sub-wavelength lithography effects.

To address the increasing relevance of global interconnect in the design of integrated circuits at nanometer-scale technology nodes, an interconnect-centric design methodology was proposed based on a three phase flow: (1) interconnect planning, (2) interconnect synthesis, (3) interconnect layout. In other words, interconnect cost must be addressed directly in every step of the design process. PHG is an important component of the initial interconnect planning step in this methodology, a component on which all downstream steps depend.

The input specification for a design (typically a Register Transfer Level description or netlist described in a Hardware Description Language) usually is described hierarchically as well. Hierarchy in the HDL description, which is called the logical hierarchy, permits the logic designers to benefit from a divide and conquer approach as well. The logical hierarchy, however, may be quite different from the physical hierarchy, which is the hierarchy ultimately used by the back-end physical design tools. Note that the physical design “back end” tools typically handle floorplanning, power planning, physical synthesis, placement, and routing tasks.

There are several reasons for this difference between logical and physical hierarchy. First, the logical hierarchy is specified for the convenience of the logic design team, while the physical hierarchy is based on the capacity of the EDA software and the feasibility of the resulting physical design task. These goals may be very different. Second, the logical hierarchy is typically much deeper than the physical hierarchy. Each additional level of physical hierarchy increases the complexity of the physical design process, and hence there are typically only one or two levels of physical hierarchy.

Third, blocks in the physical hierarchy are typically much larger than in the logical hierarchy. The flat design capacity of modern EDA software tools is quite high, and the complexity of the physical design task increases with the number of blocks, so blocks in the physical hierarchy are typically made as large as possible. Fourth, the logic design team often has little visibility into the physical design process or requirements. Thus the logical hierarchy, if used directly, might result in an extremely sub-optimal physical design. For example, all memories might have been grouped together and given to one memory design specialist. However in the physical hierarchy the memories should each be distributed into the blocks that access them. Another common example involves test logic. BIST (Built-in Self-Test) and Scan logic is often synthesized into a single hierarchical block. However in the physical design this test logic must be distributed over the floorplan or, again, long wiring delays and congestion might occur.

One way to view the PHG problem is to specify it as the problem of finding a mapping from the logical hierarchy into a physical hierarchy which is optimal with respect to the back end physical design task. Physical hierarchy generation may be viewed as a special case of the classical k-way netlist partitioning problem. However, it is different in a number of significant ways, and therefore requires a new approach and new algorithms. First, logical hierarchy needs to be followed as closely as possible, optionally even disallowing non-sibling cell grouping. Second, classical k-way partitioning algorithms usually consider k to be fixed, and it typically must be an integer power of two. In the PHG problem k is usually not pre-specified and may be any integer. Furthermore, it is not obvious a-priori what values of k may be optimal or even feasible.

Third, classical netlist partitioning seeks to optimize a simple cost function, usually the hypernet cut or maximum subdomain degree. While those figures of merit do correlate with physical parameters such as routing length and congestion, they are only indirect measures and not robust enough for an interconnect-centric flow. A novel cost function is used which measures the “affinity” of sets of cells for each other in a virtually-flat placement. Since this placement has been optimized for wire length, global routing congestion, timing etc., grouping together cells with high mutual affinity will have the effect of minimizing the disturbance on the flat placement and maintaining its optimality.

The PHG problem has been discussed previously in the industry. These discussions include a system for unified multi-level k-way partitioning, floorplanning and retiming. It uses a placement-based delay model to improve partition quality, but the placement is performed top-down on the cluster hierarchy, not virtually-flat as in one proposed embodiment. Their system requires k to be a power of 2, and makes no effort to follow the original logical hierarchy. Another describes a multilevel k-way partitioning system that exploits the logical hierarchy as a “hint” during partitioning to achieve higher quality results. They use the Rent exponent to determine which logical hierarchy modules to preserve, and use those modules as constraints during clustering. However, k must be a power of 2, and only cut-size cost (not placement or routing cost) is considered. Yet another describes a system for physical hierarchy generation based on multilevel clustering and simulated-annealing placement-based refinement, with embedded global routing to estimate and minimize congestion. The coarse placement is performed top-down and does not follow the logical hierarchy.

Formally, the PHG problem is defined as a set assignment problem that maps the logical hierarchy into the physical hierarchy. Given as inputs are a circuit netlist, the original logical hierarchy, and a set of constraints. The output is the physical hierarchy.

The netlist is specified as an undirected hypergraph G=(V, E), where v ∈ V is a set of vertices representing the leaf cells (standard cells, macros, I/O pads, etc), and e ∈ E is a set of undirected hyperedges (sometimes abbreviated to edges) connecting the vertices, e ⊂ V, representing the interconnect nets. Eᵥ ⊂ E is defined as the set of edges incident on vertex v. High fanout nets, such as the clock net, are typically ignored. Vertices and edges may each have a real number weight, wᵥ ∈ [symbol] and wₑ ∈ [symbol] respectively.

The input logical hierarchy L is a recursively defined set of subsets of V. Hierarchy L consists of one or more levels Lᵢ, 1≦i≦n, each consisting of a set of disjoint sub-sets of V that collectively cover V. Lᵢ=(L_{i,1}, L_{i,2}, . . . L_{i,j}, . . . L_{i,n}) in which L_{i,j}⊂ V for all 1≦j≦nᵢ, ∪ⱼ₌₁ⁿ^{ᵢ} L_{i,j}=V, and ∩ⱼ₌₁ⁿ^{ᵢ} L_{i,j}=Ø. In addition, each level Lₖ, 1<k≦n, is also a set of disjoint subsets of the previous level Lₖ₋₁ that collectively cover Lₖ₋₁. Lₖ=(L_{k,1}, L_{k,2}, . . . , L_{k,j}, . . . L_{k,n}_{ₖ}) in which L_{k,j}⊂ Lₖ₋₁ for all 1≦j≦nₖ, ∪ⱼ₌₁ⁿ^{ₖ} L_{k,j}=Lₖ₋₁, and ∩ⱼ₌₁ⁿ^{ₖ} L_{k,j}=Ø. Each Lᵢ is called a k-way partitioning of V, where k=|Lᵢ|. Each subset L_{i,j} is called a partition, or equivalently a cluster of vertices or their corresponding cells.

The physical hierarchy P is defined similarly. The PHG problem is to find a mapping M which maps L into P, L\vec{M}P, such that the solution is optimal with respect to some cost function, and such that the solution meets the constraints. One embodiment of the proposed process only supports a single level of physical hierarchy, but in general there is no such requirement.

The quality of the mapping M is defined by a cost function ƒ which can be any function of G, L, and P. The most common k-way partitioning cost function for a given level of the physical hierarchy Pᵢ is to minimize the sum of the cut set costs of all P_{i,j}. An edge eₖ is defined as an external edge with respect to partition P_{i,j} if eₖ ∩ P_{i,j}=Ø. Similarly, edge eₖ is defined as an internal edge with respect to P_{i,j} if eₖ ∩ P_{i,j=e}ₖ. Otherwise eₖ is called a cut edge. The cut set E_{cut}(P_{i,j})⊂ E is the set of edges in G that are cut nets with respect to P_{i,j}. The cut set cost of a partition P_{i,j} is ƒ_{cut}(P_{i,j})=Σwₑ_{ₖ}|eₖ ∈ E_{cut}(P_{i,j}), and the cut set cost of a partitioning Pᵢ is therefore ƒ_{cut}(Pᵢ)=Σⱼƒ(P_{i,j}). A slightly more complex cost function that has received recent attention in the literature is the minimization of the maximum subdomain degree.

As already described, geometric cost functions such as cut size do not have high fidelity with respect to the real physical metrics that are of interest: routability, delay, signal integrity, manufacturability, etc. Also, it is obviously desirable to maintain as much of the structure of the original logical hierarchy as possible. This goal could be addressed in the cost function, but instead is achieved intrinsically in the setup of the partitioning problem. The atomic objects which are considered for partitioning are not individual standard cells and macros, but rather are modules in the logical hierarchy which already demonstrate good placement affinity.

In addition to a cost function, a set of constraints on the solution is also required. Without a constraint on the number of required partitions, or upper and lower bounds on the partition sizes, for example, the optimal solution consists of a single cluster of all cells in G. (That degenerate solution has a cut of zero, equivalent to a flat instance of the design.) Many other constraints are possible. One author solved an instance of the partitioning problem for FPGAs subject to component resource capacity constraints.

Another common requirement is support for repeated blocks (RBs), sometimes also called multiply instantiated blocks (MIBs). This requirement is most easily expressed as a constraint. If an instance of an RB in the logical hierarchy becomes a partition in the physical hierarchy, then all instances of that RB must also become partitions. Furthermore, all such partitions must be identical. Other cells (such as small clusters or glue logic cells) may only be merged into an RB partition if identical instances can be merged into all instances of the RB.

Another common requirement is support for multiple power domains. A power domain is a set of leaf cells sharing a common power supply. Different power domains may use different voltages to achieve different power/performance tradeoffs. Alternately they may use the same voltage, but with different power gating control circuitry that switches off power to the cells when they are not in use. Splitting a power domain into two partitions is not desirable because of the extra overhead required to distribute the power supply voltage to each partition, and to duplicate associated level shifting cells and/or power gating logic to each partition. In the context of the PHG problem, one could to treat the power domains as constraints, preventing cells in different power domains from being clustered together. Or one could consider the domains with a term in the cost function that would minimize the “power domain cut set” (the number of partition boundaries that split a given domain into different partitions.

Yet another common requirement is support for multiple clock domains. A clock domain is a set of leaf cell latches or flip flops that share a particular clock distribution network. Different clock domains may operate at different clock frequencies or duty cycles, for example, or they may be different versions of a common clock that are gated to switch off the clock to portions of the circuit that are not in use during a particular clock cycle. Splitting a clock domain into two partitions is not desirable because of the extra overhead required to route the clock network to each partition, or to duplicate the clock gating logic in each partition. As with power domains, clock domains may be considered either as hard constraints during the PHG problem, or as an additional term in the cost function that minimizes the “clock domain cut set”.

Therefore, the problem addressed by this disclosure includes partitioning that keeps logical and physical hierarchy as similar as possible. One embodiment also removes restrictions on the allowable number for k in the case of k-way partitioning and allows k to adapt to the needs of the design rather than simply be pre-defined. One embodiment further factors in a specialized cost function based on the result of virtually-flat placement. Other embodiments add restrictions based on repeated blocks, multiple power domains, or multiple clock domains in the selection of the blocks or components that compose the partitioning.

### SUMMARY

The described embodiments provide systems and methods for generation of a physical hierarchy. In one embodiment, a virtually-flat placement of a logically hierarchical design having a plurality of cells is received. A placement affinity metric is calculated in response to receiving the virtually-flat placement. In one embodiment a plurality of cells is coarsened by clustering cells in the logical hierarchical design using the calculated placement affinity metric. In another embodiment, initial partitions of clustered cells are refined by selecting at least one cluster to move between the partitions using the placement affinity metric.

In one embodiment, virtually-flat mixed-mode placement comprises simultaneous global placement of standard cells and macros, ignoring the logical hierarchy. The placement is minimized for wire length and congestion. Hard macro legalization is optional. The placement affinity metric, based on the mutual affinity of one cell, or cluster of cells, for another in the virtually-flat mixed-mode placement is utilized in the optimization cost function.

An embodiment of a method also includes pre-clustering. This includes processing the logical hierarchy in a top-down levelized order to locate and pre-cluster logical hierarchy cells with high placement affinity. An embodiment including graph coarsening comprises a method that performs a bottom-up clustering to reduce the size of the hypergraph, using the best choice clustering heuristic and a lazy update scheme for neighbor cost updates. A method also may include initial partition generation. For example, using a simplified netlist produced by graph coarsening, the method creates an initial k-way partitioning of reasonable quality that meets the constraints. Further, graph uncoarsening and refinement performs top-down declustering, using an iterative refinement process at each level to improve the initial partition from initial partition generation. Finally, there may be multi-phase refinement in which steps for graph coarsening, initial partition generation, and graph uncoarsening and refinement may occur zero or more times until partitioning converges.

The process described may also be embodied as instructions that can be stored within a computer readable storage medium (e.g., a memory or disk) and can be executed by a processor.

The features and advantages described herein are not all inclusive, and, in particular, many additional features and advantages will be apparent to one skilled in the art in view of the drawings, specifications, and claims. Moreover, it should be noted that the language used in the specification has been principally selected for readability and instructional purposes and may not have been selected to circumscribe the claimed invention.

### BRIEF DESCRIPTION OF THE DRAWINGS

The teachings of the disclosure herein can be readily understood by considering the following detailed description in conjunction with the accompanying drawings. Like reference numerals are used for like elements in the accompanying drawings.

FIG. 1 is a flow chart illustrating one embodiment of a method for placement-driven physical-hierarchy generation.

FIG. 2 is a schematic diagram illustrating one embodiment of a physical and a logical hierarchy on a chip.

FIG. 3 is a schematic diagram illustrating one embodiment of a design V-cycle involving clustering, declustering, and refinement.

FIGS. 4A,B is a schematic diagram illustrating one embodiment of affinity cost for low and high affinity clusters.

FIGS. 5A-C is a schematic diagram illustrating examples of placement affinity.

The figures depict embodiments for purposes of illustration only. One skilled in the art will readily recognize from the following discussion that alternative embodiments of the structures and methods illustrated herein may be employed without departing from the principles of the disclosure herein.

### DETAILED DESCRIPTION

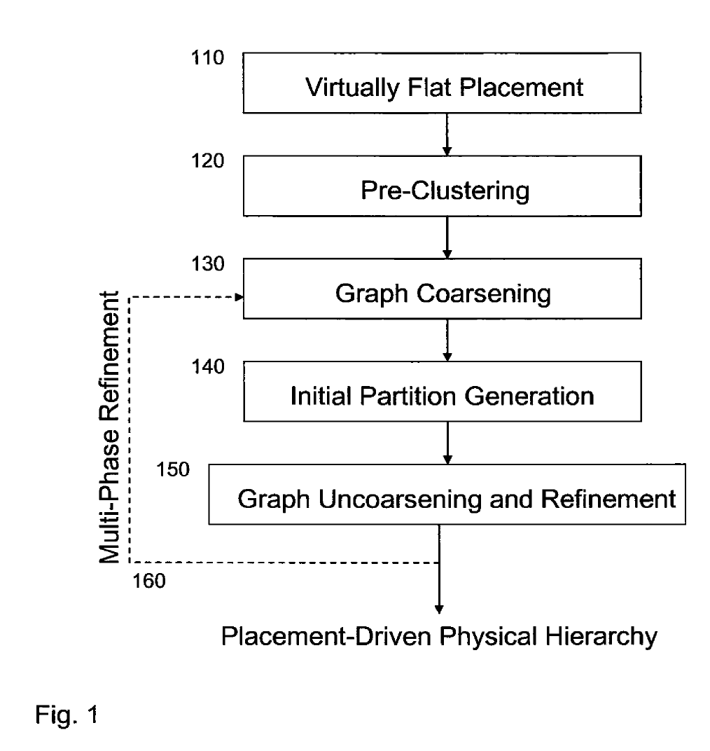

Methods (and systems) for generation of a physical hierarchy based on placement are described. FIG. 1 is a flow chart illustrating a method for placement-driven physical-hierarchy generation in accordance with one embodiment. One of ordinary skill in the art will recognize that in alternative embodiments, some of the steps described in FIG. 1 are optional, and in addition, the steps can be performed in a different order. Examples of alternative embodiments follow the description of steps. Thus, FIG. 1 is merely an example of one embodiment.

A. Virtually-Flat Placement

Referring to FIG. 1, step 110 is the process of virtually-flat placement. By running a virtually-flat mixed-mode global placer on the entire design a first pass layout is accomplished. The phrase “virtually-flat” means placing all of the leaf cells in the design as if it were flat, even though it is not in fact actually flat. The intermediate levels of logical hierarchy are ignored. A global placer is responsible for finding approximate locations for the cells such that they are suitably spread out to satisfy routability-driven density requirements, while minimizing metrics such as wire length, congestion, critical path delay, etc. Global placement is not required to completely de-overlap the cells. A virtually-flat placer is one that ignores the logical hierarchy, placing all cells as if the design were flat. Virtually-flat placers must typically work on very large data sets, and therefore, usually have to sacrifice some degradation in quality to achieve the required capacity and runtime. A mixed-mode placer is typically defined as a placer that simultaneously places small standard cells with much larger hard macros and soft macros.

In one embodiment, the PHG process receives a virtually-flat placement of a logically hierarchical design and calculates a placement affinity metric for use in the partitioning phase. Global placers are extremely good at optimizing wire length over many different connectivity scales, and the Manhattan distance between two cells (or sets of cells) may be used as a fairly reliable indication of their degree of connectivity. During partitioning, one can view the placement affinity as a tie-breaker: selecting between two possible clusterings with equal cut-size reduction, one embodiment will choose to cluster the groups with higher placement affinity. Placement affinity is further described below.

B. Pre-Clustering

Referring next to step 120 in FIG. 1, there is a process of pre-clustering the layout. During the pre-clustering step, the logical hierarchy is processed to set up the netlist partitioning problem. Typical netlist partitioners take a list of the design's leaf cells (standard cells and hard macros) as their atomic input objects, distributing the cells into partitions regardless of their original hierarchy relationships. However, as discussed earlier, it is very desirable from a usability perspective to maintain as much of the logic designer's logical hierarchy as possible. Most EDA physical design software requires that the top level, as well as the soft macros, be flattened before physical implementation, thus losing the structure of the logical hierarchy and only preserving the physical hierarchy. However, it is a fairly simple matter in one embodiment to mark those nets at the logical hierarchy boundaries and re-construct selected levels of logical hierarchy for output to the user. Minor modifications to the logical hierarchy, for example, grouping of sibling modules, will not affect such marking. However, large scale hierarchy modification, such as the clustering of non-sibling cells from the logical hierarchy, may not be maintained. Thus, in some embodiments, these are minimized or disallowed.

One embodiment preserves the logical hierarchy intrinsically through pre-clustering of leaf cells based on their logical hierarchy relationships. In one embodiment, leaf cells are pre-clustered in a top-down order. In a top-down process, processing begins at the highest level of the logical hierarchy and proceeds downward, successively processing smaller and smaller cells. Starting at the top level, the process recursively de-clusters cells in the logical hierarchy until it reaches a set of cells that satisfy the user supplied maximum-cell-count threshold constraint. In addition, it measures their leaf cell's mutual placement affinity which will be defined in greater detail later. If the affinity of a cell is below an empirically derived threshold the process automatically de-clusters that cell and tests the cells in the next level of logical hierarchy. These pre-clustered logical hierarchy modules, along with any glue logic leaf cells instantiated by the de-clustered hierarchy modules, become the initial set of vertices in the partitioning hypergraph. While the described embodiment includes an empirically derived affinity it should be noted that other possible embodiments include fixed values or those derived adaptively by examining the affinity of a cell's children or grandchildren for better affinity values.

C. Graph Coarsening

Turning next to step 130 in FIG. 1, it represents a process of graph coarsening. In the graph coarsening phase, one embodiment iteratively merges sets of connected vertices to produce a sequence of successively coarser reduced graphs. The goal is to merge vertices with high local connectivity, thus reducing the number of vertices and edges in the graph. The initial partitioning step will run much more quickly, and it should help to achieve a better quality initial partition. Recall that the term vertices refers to cells (or clusters of cells) while edges refers to nets. While vertices and edges are typically used in graph theory, cells and nets are typically used to describe logic circuitry. Thus, it should be understood that graph coarsening can also describe coarsening, or clustering, of cells.

In one embodiment, the graph coarsening step 130 comprises coarsening a plurality of cells by clustering cells using a placement affinity metric. The placement affinity metric will be described below. In one embodiment, graph coarsening comprises creating a bottom-up clustering of cells. In a bottom-up process, processing begins at the lowest level (for example, the leaf cells and pre-clustered logical hierarchy cells obtained from pre-clustering) and proceeds upwards, successively merging pairs of smaller clusters to form new larger clusters.

This hierarchically defined sequence of successively coarse sub-graphs encodes connectivity relationships in the graph at successively larger length scales. The first iteration merges vertices with direct connections. The second iteration merges vertices connected through one common vertex, etc. The uncoarsening and refinement stage will later make use of this information to improve the partition as each level is unclustered in reverse order, optimizing the partition cut at each of those different length scales. This is the key idea behind the efficacy of using steps 130 through 160.

It is noted that examples of coarsening approaches include edge coarsening (EC), hyperedge coarsening (HEC) and first-choice coarsening (FCC) schemes. A particular embodiment uses a scheme referred to in the literature as best-choice clustering (BCC). The BCC process is discussed further below.

When two vertices vₐ and v_{b} are merged the graph G is modified as follows. Vertices vₐ and v_{b} are removed and a new vertex v_{a∪b} is added with weight wᵥ_{_{a∪b}}=wᵥ_{ₐ}+wᵥ_{_{b}}. All hypernets that were incident to vₐ or v_{b} are attached to v_{a∪b}, with the exception of hypernets incident only to vₐ and v_{b}, which are deleted. Two hypernets n_{c} and n_{d} which, after the merge, have identical sets of sinks, can be removed and replaced with a single hypernet n_{c∪d} with weight wₙ_{_{c∪d}}=wₙ_{_{c}}+wₙ_{_{d}}. This latter optimization can have a big impact on runtime by reducing the number of nets significantly.

The coarsening schemes operate on pairs of vertices (EC, FCC, BC) or sets of hyperedge sinks (HEC). Thus, the process defines how many coarsening operations are to be performed before defining a new coarsening “level” and creating a new reduced graph instance. It is noted that each coarsening level is used to define an iteration in the uncoarsening and refinement step. For example, it has been observed that a balance between quality and runtime may be achieved when the size of the successive graphs is reduced by a factor of 1.5-1.8.

1. Graph Coarsening: Best Choice Clustering (BCC)

Best Choice Clustering uses a priority queue to track the globally best merge choice encountered from among all of the possibilities. This Best Choice Clustering uses a cost function to compute a clustering score S_{a∪b} for all pairs of connected vertices vₐ and v_{b}. A record is maintained for each vertex referencing its neighbor with the highest score. These records are placed into a priority queue (PQ), sorted by score, so that the clustering choice with the globally highest score can be obtained in O(1) time. The selected vertices are merged into a larger vertex v_{a∪b}, and the process is repeated until a certain stopping criterion is met.

After the vertex v_{a∪b} is formed, its best neighbor must be found, and a new PQ record must be created and inserted into the queue. In addition, the existing entries in the PQ must be searched for references to vₐ and v_{b}. Vertices that were previously neighbors of vₐ and v_{b} are now neighbors of v_{a∪b}. Their new best-choice must be found, and their records must be re-inserted into the PQ as well.

a. Graph Coarsening Score

This section describes a cost function score used during the coarsening phase of the multilevel partitioning process. The score is a multi-variable cost function with two or more terms. The first term reflects the number of pins eliminated by the merge, normalized by the maximum possible gain. The second term is a new metric based on a measurement of the placement affinity of the cells in a virtually-flat placement. The placement affinity describes how closely the cells of a virtually-flat placement are located to one another.

(i) Pin Reduction

As described above, Eᵥ ⊂ E is the set of hyperedges incident on vertex v. Also defined is W_{E}_{ᵥ} as the sum of the weights of the edges in Eᵥ, W_{E}_{ᵥ}=Σwₑ_{ᵢ}|eᵢ ∈ Eᵥ. This latter value is equivalent to the number of pins on the cluster of cells C represented by v. When two vertices, a ∈ V and b ∈ V, are merged during coarsening; some hyperedges and their associated pins may disappear if they connect only a and b. A pin-reduction score Sₚᵢₙ(a ∪ b) is defined for the coarsening merge a ∪ b as follows:

$${S}_{pin} ( a ⋃ b ) = \frac{{W}_{{E}_{a}} + {W}_{{E}_{b}} - {W}_{{E}_{a ⋃ b}}}{{W}_{{E}_{a}} + {W}_{{E}_{b}}} \qquad ( 1 )$$

The denominator normalizes the function so that it is independent of cluster size. Otherwise the partitioner would favor the merge of large cell clusters over small cell clusters, as more pins would likely disappear. It also serves to scale the function such that it can be effectively combined with the placement affinity term as described below.

After normalization this metric is a unitless number between zero and one. When W_{E}_{_{a∪b}}=0 (its lower bound), then Sₚᵢₙ(a ∪ b)=1.0 (its upper bound). Alternatively, when W_{E}_{_{a∪b}}=W_{E}_{ₐ}+W_{E}_{_{b}} (its upper bound), then Sₚᵢₙ(a ∪ b)=0 (its lower bound).

(ii) Placement Affinity

The placement affinity term, in one embodiment represented by Mₚₗ, in the coarsening score is used to guide the partitioning decisions based on the virtually-flat mixed-mode placement results. In one embodiment, the placement affinity metric quantifies the relative proximity of cells to each other in a cluster as a result of forming the cluster during coarsening. The placement, which has been optimized for wire length and congestion, provides useful information about the complex connectivity relationships between cells and clusters of cells. If two cell clusters are placed close to one another then it is likely that they communicate with one another. If all cells in a cluster are placed close to one another then it is likely that they have high relative connectivity and should remain clustered. Conversely, if the cells in a cluster are scattered across the entire surface of the chip, it is likely that they should be de-clustered in the physical hierarchy.

Given a vertex v ∈ V in G which represents a cluster C of two or more cells, C={c₁, c₂, . . . , cₙ, the placement affinity of the cells is quantitatively measured. One simple way of doing this is to use the maximum enclosing bounding box over all cells in the cluster, bbₘₐₓ(C). The computational complexity to calculate bbₘₐₓ(C) is O(n), where n=|C|, since the cells must be iterated over one time. It is noted that this metric may be strongly impacted by “outliers”, cells that are pulled far from the center of mass.

Another possibility is to think of the cell placement as a probability distribution function over the x and y placement axis. The cells will have a center of mass described by the mean μ of the cell's coordinates in x and y. One can also measure the standard deviation σ of the placement in x and y. The standard deviation is a measure of how “spread out” the cells are in the placement, and is defined as the root mean squared (RMS) of the deviation of each cell from the mean. The standard deviation has the same units as the data being measured, in this case units of distance. It can be thought of as the average distance of the cells from the mean.

If a rectangle R_{σ}(C) is drawn with the following coordinates

$$\begin{matrix}{R}_{σ} ( C ) = ( {x}_{l} , {x}_{r} , {y}_{b} , {y}_{t} ) \\ = ( {μ}_{x} - \frac{{σ}_{x}}{2} , {μ}_{x} + \frac{{σ}_{x}}{2} , μ - \frac{{σ}_{x}}{2} , {μ}_{x} + \frac{{σ}_{x}}{2} )\end{matrix} \qquad ( 2 )$$

it provides a good measure of the placement affinity of the cells in the set. The area of the rectangle is proportional to the average distance of the cells from the mean. Because the standard deviation is much less sensitive to outliers than the bbₘₐₓ(C) function, the latter technique may be more tolerant of small placement abnormalities. As described below, the computational complexity of the standard deviation metric is also O(n).

A review of the definitions of the mean and standard deviation functions is now provided. A more computationally efficient formulation of the standard deviation expression is given and then derived equations for the mean and standard deviation of a rectangular region and of sets of such regions are described.

The arithmetic mean μₚ of a population p={p₁, p₂, . . . , pₙ}, where pᵢ ∈ [symbol] for all i=1 . . . . n, is defined as

$${μ}_{p} = \frac{1}{n} {\sum }_{i = 1}^{n} {p}_{i} \qquad ( 3 )$$

For convenience, μₚ_{²} is defined as the mean of the squares of p

$${μ}_{{p}^{2}} = \frac{1}{n} {\sum }_{i = 1}^{n} {p}_{i}^{2} \qquad ( 4 )$$

The standard deviation σₚ of population p is defined as

$${σ}_{p} = \sqrt{\frac{1}{n} {\sum }_{i = 1}^{n} {( {p}_{i} - {μ}_{p} )}^{2}} \qquad ( 5 )$$

It is easily shown that equation 5 can be re-written in a more convenient form, as shown below in theorem 1. Theorem 1 below is an alternative formulation of standard deviation is:
σₚ=\sqrt{μₚ_{²}−μₚ²} (6)

$$\begin{matrix}A proof of Theorem 1 is now provided \text{:} \\ The arithmetic mean {μ}_{p} of a population p is defined as & \\ {μ}_{p} = \frac{1}{n} {\sum }_{i = 1}^{n} {p}_{i} & ( 7 ) \\ For convenience , {μ}_{{p}^{2}} is defined as the mean of the squares of p . & \\ {μ}_{{p}^{2}} = \frac{1}{n} {\sum }_{i = 1}^{n} {p}_{i}^{2} & ( 8 ) \\ The standard deviation {σ}_{p} of population p is defined as & \\ {σ}_{p} = \sqrt{\frac{1}{n} {\sum }_{i = 1}^{n} {( {p}_{i} - {μ}_{p} )}^{2}} & ( 9 ) \\ Because the summation operator is associative this can be re \text{-} written as & \\ {σ}_{p}^{2} = \frac{1}{n} ( {\sum }_{i = 1}^{n} {p}_{i}^{2} - {\sum }_{i = 1}^{n} 2 {p}_{i} {μ}_{p} + {\sum }_{i = 1}^{n} {μ}_{p}^{2} ) & ( 10 ) \\ Because the summation operator is distributive , and because {μ}_{p} is a constant , equation 10 can be re \text{-} written as follows & \\ {σ}_{p}^{2} = \frac{1}{n} ( {\sum }_{i = 1}^{n} {p}_{i}^{2} - 2 {μ}_{p} {\sum }_{i = 1}^{n} {p}_{i} + n {μ}_{p}^{2} ) & ( 11 ) \\ {σ}_{p}^{2} = {μ}_{{p}^{2}} - 2 {μ}_{p}^{2} + {μ}_{p}^{2} & ( 12 ) \\ {σ}_{p}^{2} = {μ}_{{p}^{2}} - {μ}_{p}^{2} & ( 13 ) \\ {σ}_{p} = \sqrt{{μ}_{{p}^{2}} - {μ}_{p}^{2}} \\ QED . & ( 14 )\end{matrix}$$

When computing the standard deviation, equation 6 has an advantage over equation 5, in that it allows single-pass computation of σₚ. To calculate σₚ using equation 5 requires one pass to compute μₚ and a second pass to sum the (pᵢ−μₚ) values. Using equation 6 the values of μₚ_{²} and μₚ² may be calculated in a single pass which can result in a significant runtime savings if the size of population p is large. Computing μₚ_{²} and μₚ² requires O(|p|) time. Computing σₚ can then be performed in constant time.

Another useful property of the standard deviation is shown below in theorem 2. The proof, based on the fact that summation is distributive, is straightforward. Theorem 2 below is a mean and standard deviation for the union of two populations p and q, that are:

$$\begin{matrix}{μ}_{p ⋃ q} = \frac{{\sum }_{i = 1}^{n} {p}_{i} + {\sum }_{j = 1}^{m} {q}_{j}}{n + m} = \frac{n}{n + m} {μ}_{p} + \frac{m}{n + m} {μ}_{q} & ( 15 ) \\ {μ}_{{( p ⋃ q )}^{2}} = \frac{{\sum }_{i = 1}^{n} {p}_{i}^{2} + {\sum }_{j = 1}^{m} {q}_{j}^{2}}{n + m} = \frac{n}{n + m} {μ}_{{p}^{2}} + \frac{m}{n + m} {μ}_{{q}^{2}} & ( 16 ) \\ {σ}_{p ⋃ q} = \sqrt{{μ}_{{( p ⋃ q )}^{2}} - {( {μ}_{p ⋃ q} )}^{2}} & ( 17 )\end{matrix}$$

Equations 15-17 demonstrate that, once the mean has been computed for populations p and q, the mean and standard deviation for the combined population p ⊂ q can be computed in constant time. If one caches μₚ, μₚ_{²}, n, and m, for each population p, populations can be combined without iterating their individual elements. Naturally this is a very useful property during the coarsening phase of the multilevel partitioning process.

Equation 6 shows how to calculate the standard deviation for a finite “population” of real numbers. Theorem 3 is used to relate this to a placement of standard cells and macros, which are boxes with finite width and height, rather than zero-dimensional points. Theorem 3 below is a mean and standard deviation in x and y of all points in a rectangle R defined by the closed interval [x₁,xᵣ] on the x axis, and the closed interval [y_{b},yₜ] on the y axis, which are:

$$\begin{matrix}{μ}_{{R}_{x}} = \frac{{x}_{l} + {x}_{r}}{2} & ( 18 ) \\ {μ}_{{R}_{y}} = \frac{{y}_{b} + {y}_{t}}{2} & ( 19 ) \\ {μ}_{{R}_{x}^{2}} = \frac{{x}_{r}^{3} - {x}_{l}^{3}}{3 ( {x}_{r} - {x}_{l} )} & ( 20 ) \\ {μ}_{{R}_{y}^{2}} = \frac{{y}_{t}^{3} - {y}_{b}^{3}}{3 ( {y}_{t} - {y}_{b} )} & ( 21 ) \\ {σ}_{{R}_{x}} = \frac{( {x}_{r} - {x}_{l} )}{\sqrt{12}} = \frac{{width}_{R}}{\sqrt{12}} & ( 22 ) \\ {σ}_{{R}_{y}} = \frac{( {y}_{t} - {y}_{b} )}{\sqrt{12}} = \frac{{height}_{R}}{\sqrt{12}} & ( 23 )\end{matrix}$$

$$\begin{matrix}A proof of Theorem 3 is now provided \text{:} \\ The objective is to find the mean and standard deviation , with respect to both the x and y axis , of all points in a rectangle defined by the closed intervals x = [ {x}_{l} , {x}_{r} ] and y = [ {y}_{b} , {y}_{t} ] \\ The mean value ( also called the center of mass , or centroid ) of a 2 dimensional region Ω , with respect to the x axis , is given by the following equation \\ {μ}_{x} = \frac{{\int \int }_{Ω} x ⅆ x ⅆ y}{{\int \int }_{Ω} ⅆ x ⅆ y} = \frac{{\int \int }_{Ω} x ⅆ x ⅆ y}{{area}_{Ω}} & ( 24 ) \\ For rectangular region R defined by {x}_{l} \leq x \leq {x}_{r} and {y}_{b} \leq y \leq {y}_{t} this becomes & ( 25 ) \\ \begin{matrix}{μ}_{{R}_{x}} = \frac{{\int }_{{y}_{b}}^{{y}_{t}} [ {\int }_{{x}_{l}}^{{x}_{r}} x ⅆ x ] ⅆ y}{{\int }_{{y}_{b}}^{{y}_{t}} [ {\int }_{{x}_{l}}^{{x}_{r}} ⅆ x ] ⅆ y} \\ = \frac{{[ y ]}_{{y}_{b}}^{{y}_{t}} {\int }_{{x}_{l}}^{{x}_{r}} x ⅆ x}{{[ y ]}_{{y}_{b}}^{{y}_{t}} {\int }_{{x}_{l}}^{{x}_{r}} ⅆ x} \\ = \frac{( {y}_{t} - {y}_{b} ) \frac{{[ {x}^{2} ]}_{{x}_{l}}^{{x}_{r}}}{2}}{{( {y}_{t} - {y}_{b} ) [ x ]}_{{x}_{l}}^{{x}_{r}}} \\ = \frac{( {x}_{r}^{2} - {x}_{l}^{2} )}{2 ( {x}_{r} - {x}_{l} )} \\ = \frac{( {x}_{r} + {x}_{l} ) ( {x}_{r} - {x}_{l} )}{2 ( {x}_{r} - {x}_{l} )} \\ = \frac{{x}_{r} + {x}_{l}}{2}\end{matrix} & ( 26 ) \\ Similarily , with respect to the y axis \\ {μ}_{{R}_{x}} = \frac{{\int \int }_{Ω} y ⅆ x ⅆ y}{{\int \int }_{Ω} ⅆ x ⅆ y} = \frac{{y}_{t} + {y}_{b}}{2} & ( 27 ) \\ This proves equations 18 and 19. This result , that the center of gravity of points in a rectangle is at the center of the rectangle , is of course intuitive . Now , using the same technique , {μ}_{{R}_{x}^{2}} and {μ}_{{R}_{y}^{2}} is found for rectangle R \\ \begin{matrix}{μ}_{{R}_{x}^{2}} = \frac{{\int }_{{y}_{b}}^{{y}_{t}} [ {\int }_{{x}_{l}}^{{x}_{r}} {x}^{2} ⅆ x ] ⅆ y}{{\int }_{{y}_{b}}^{{y}_{t}} [ {\int }_{{x}_{l}}^{{x}_{r}} ⅆ x ] ⅆ y} \\ = \frac{{[ y ]}_{{y}_{b}}^{{y}_{t}} {\int }_{{x}_{l}}^{{x}_{r}} x ⅆ x}{{[ y ]}_{{y}_{b}}^{{y}_{t}} {\int }_{{x}_{l}}^{{x}_{r}} ⅆ x} \\ = \frac{( {y}_{t} - {y}_{b} ) \frac{{[ {x}^{3} ]}_{{x}_{l}}^{{x}_{r}}}{3}}{{( {y}_{t} - {y}_{b} ) [ x ]}_{{x}_{l}}^{{x}_{r}}} \\ = \frac{( {x}_{r}^{3} - {x}_{l}^{3} )}{3 ( {x}_{r} - {x}_{i} )}\end{matrix} & ( 28 ) \\ Similarily , with respect to the y axis \\ {μ}_{{R}_{y}^{2}} = \frac{{y}_{t}^{3} - {y}_{b}^{3}}{3 ( {x}_{t} - {x}_{b} )} & ( 29 ) \\ This proves equations 20 and 21. Now the standard deviation is found of R in x and y , {σ}_{x} and {σ}_{y} . From equation 6 it is given that \\ {σ}_{p} = \sqrt{{μ}_{{p}^{2}} - {μ}_{p}^{2}} & ( 30 ) \\ Substituing the expressions calculated above , and expanding , it follows that & ( 31 ) \\ \begin{matrix}{σ}_{x}^{2} = {μ}_{{x}^{2}} - {μ}_{x}^{2} \\ = \frac{{x}_{r}^{3} - {x}_{l}^{3}}{3 ( {x}_{r} - {x}_{l} )} - {( \frac{{x}_{r} + {x}_{l}}{2} )}^{2} \\ = \frac{{x}_{r}^{3} - {x}_{l}^{3}}{3 ( {x}_{r} - {x}_{l} )} - \frac{( {x}_{r} - {x}_{l} ) {( {x}_{r} + {x}_{l} )}^{2}}{4 ( {x}_{r} - {x}_{l} )} \\ = \frac{4 ( {x}_{r}^{3} - {x}_{l}^{3} ) - 3 ( {x}_{r}^{3} + {x}_{l} {x}_{r}^{2} - {x}_{l}^{2} {x}_{r} - {x}_{l}^{3} )}{12 ( {x}_{r} - {x}_{l} )} \\ = \frac{{x}_{r}^{3} - 3 {x}_{l} {x}_{r}^{2} + 3 {x}_{l}^{2} {x}_{r} - {x}_{l}^{3}}{12 ( {x}_{r} - {x}_{l} )} \\ = \frac{{( {x}_{r} - {x}_{l} )}^{3}}{12 ( {x}_{r} - {x}_{l} )} \\ = \frac{{( {x}_{r} - {x}_{l} )}^{2}}{12}\end{matrix} & ( 32 ) \\ \begin{matrix}{σ}_{x} = \sqrt{\frac{{( {x}_{r} - {x}_{l} )}^{2}}{12}} \\ = \frac{{x}_{r} - {x}_{l}}{\sqrt{12}} \\ = \frac{{width}_{R}}{\sqrt{12}}\end{matrix} & ( 33 ) \\ And similarly for {σ}_{y} \\ \begin{matrix}{σ}_{y} = \sqrt{\frac{{( {y}_{t} - {y}_{b} )}^{2}}{12}} \\ = \frac{{y}_{t} - {y}_{b}}{\sqrt{12}} \\ = \frac{{height}_{R}}{\sqrt{12}}\end{matrix} \\ This proves equations 22 and 23. \\ QED . & ( 34 )\end{matrix}$$

It is also easy to derive an analogy to equations 15-17, which are defined over discrete populations of real numbers, for use with continuous bounded functions. This is shown below in theorem 4. The proof, using equation 24 is straightforward. Theorem 4 below includes mean and standard deviation in x and y of the union of two rectangles R₁ and R₂ with areas A_{R}_{₁} and A_{R}_{₂}

$$\begin{matrix}{μ}_{{( {R}_{1} ⋃ {R}_{2} )}_{x}} = \frac{{A}_{{R}_{1}}}{{A}_{{R}_{1}} + {A}_{{R}_{2}}} {μ}_{{R}_{{1}_{x}}} + \frac{{A}_{{R}_{2}}}{{A}_{{R}_{1}} + {A}_{{R}_{2}}} {μ}_{{R}_{{2}_{x}}} & ( 35 ) \\ {μ}_{{( {R}_{1} ⋃ {R}_{2} )}_{y}} = \frac{{A}_{{R}_{1}}}{{A}_{{R}_{1}} + {A}_{{R}_{2}}} {μ}_{{R}_{{1}_{y}}} + \frac{{A}_{{R}_{2}}}{{A}_{{R}_{1}} + {A}_{{R}_{2}}} {μ}_{{R}_{{2}_{y}}} & ( 36 ) \\ {μ}_{{( {R}_{1} ⋃ {R}_{2} )}_{x}^{2}} = \frac{{A}_{{R}_{1}}}{{A}_{{R}_{1}} + {A}_{{R}_{2}}} {μ}_{{R}_{{1}_{x}^{2}}} + \frac{{A}_{{R}_{2}}}{{A}_{{R}_{1}} + {A}_{{R}_{2}}} {μ}_{{R}_{{2}_{x}^{2}}} & ( 37 ) \\ {μ}_{{( {R}_{1} ⋃ {R}_{2} )}_{y}^{2}} = \frac{{A}_{{R}_{1}}}{{A}_{{R}_{1}} + {A}_{{R}_{2}}} {μ}_{{R}_{1 y}} + \frac{{A}_{{R}_{2}}}{{A}_{{R}_{1}} + {A}_{{R}_{2}}} {μ}_{{R}_{{2}_{y}^{2}}} & ( 38 ) \\ {σ}_{{R}_{1} ⋃ {R}_{2}} = \sqrt{{μ}_{{( {R}_{1} ⋃ {R}_{2} )}_{x}^{2}} - {( {μ}_{{( {R}_{1} ⋃ {R}_{2} )}_{x}} )}^{2}} & ( 39 ) \\ {σ}_{{R}_{1} ⋃ {R}_{2}} = \sqrt{{μ}_{{( {R}_{1} ⋃ {R}_{2} )}_{y}^{2}} - {( {μ}_{( {R}_{1} ⋃ {R}_{2} )} )}^{2}} & ( 40 )\end{matrix}$$

Theorem 4 shows how to compute the mean and standard deviation values, with respect to either the x or y axis, over the volume of a rectangle R. To analyze the placement affinity for a set of two or more standard cells or macro cells C={c₁, c₂ . . . cₙ} equations 18-21 are used to compute μ_{c}_{ᵢₓ}, μ_{c}_{_{iy}}, μ_{c}_{ᵢₓ}_{²} and μ_{c}_{_{iy}}_{²} for each cell cᵢ ∈ C. Equations 35-40 are then used to compute the cumulative standard deviations in both x and y, σ_{C}_{ₓ} and σ_{C}_{_{y}}, for the entire set C. The values μ_{C}_{ₓ}, μ_{C}_{_{y}}, μ_{C}_{ₓ}_{²} and μ_{C}_{_{y}}_{²} can then be cached, and the process repeated to form a larger sets.

All that remains is to show how σ_{C}_{ₓ} and σ_{C}_{_{y}} are used to measure the placement affinity of the set of cells C. The following corollary to theorem 3 is given below. Corollary 1: product of the standard deviations in x and y of all points in a rectangle defined by the closed interval [x₁,xᵣ] on the x axis, and the closed interval [y_{b},yₜ] on the y axis

$$\begin{matrix}{σ}_{{R}_{x}} \times {σ}_{{R}_{y}} = \frac{( {x}_{r} - {x}_{l} ) ( {y}_{t} - {y}_{b} )}{12} = \frac{{area}_{R}}{12} & ( 41 ) \\ {area}_{R} = 12 ( {σ}_{{R}_{x}} \times {σ}_{{R}_{y}} ) & ( 42 )\end{matrix}$$

Equation 41 of corollary 1 shows that computing the standard deviations in x and y of all points in a rectangle R, and using those values as the x and y dimensions of a new rectangle R_{σ}, then R_{σ} will always have an area of 1/12 the area of the original rectangle. This is independent of the size of the original rectangle.

This property demonstrates that the standard deviation metric does not have a bias for large groups of cells over small groups of cells, or vice versa. Conversely, Equation 42 shows that the area of rectangle R is always 12 times the area of R_{σ}. The area of a single cell will always be 12× the standard deviation product of its bounding box.

In one embodiment, an ideal bounding box is defined to be the bounding box of the best possible placement of the cells. The observed bounding box of the set of cells, on the other hand, is measured by computing (using equations 18-21 and 35-40) twelve times the product of the cumulative standard deviations in x and y, given their actual placement in the floorplan.

A placement affinity metric, Mₚₗ, is defined as the ratio of the areas of the observed bounding box and the ideal bounding box, as shown below

$$\begin{matrix}{area ( C )}_{ideal} = {\sum }_{i = 1}^{\vert C \vert} area ( {c}_{i} ) & ( 43 ) \\ {area ( C )}_{observed} = 12 ( {σ}_{{C}_{x}} \times {σ}_{{C}_{y}} ) & ( 44 ) \\ {M}_{pl} ( C ) = \frac{{area ( C )}_{observed}}{{area ( C )}_{ideal}} = \frac{12 ( {σ}_{{C}_{x}} \times {σ}_{{C}_{y}} )}{{\sum }_{i = 1}^{\vert C \vert} area ( {c}_{i} )} & ( 45 )\end{matrix}$$

Note that if the cells are placed in a minimum-area circle, the horizontal and vertical standard deviation values and ideal area will actually be smaller than the lower bound obtained from the ideal square bounding box. An analytical expression for the standard deviation over a circle could be developed, but since the lower bound is only being used as a scaling factor, it would make little difference.

Also note that a set of cells placed with zero whitespace, as in the ideal lower bound, would in most cases result in an un-routable design. Global cell placers typically spread the cells out with a non-zero amount of white space, either at a constant user-defined utilization value, or with dynamically controlled local routability estimates, in a process called whitespace management. Utilization can be defined as a real number between 0.0 and 1.0, indicating the average amount of “white space” that is to be left between cells in the placement. It may also be specified as a percentage between 0% and 100%.

The metric given in equation 45 is a unitless number≧1.0, which has the value 1.0 when the cells are placed in their minimum possible rectangular bounding box and increases as the cells are spread farther apart. It has a very loose upper bound, achieved when two cells are placed in opposite corners of the floorplan.

Equation 45 can be used directly to compare the absolute placement affinities of two different sets of cells, as required in the pre-clustering phase of the process described above. Or it can be used to compute the Best Choice Clustering score, as required in the coarsening phase described above as follows.

When two sets of one or more cells C₁ and C₂ are clustered into a larger set C₁ ∪ C₂, the placement affinity of the merged set may be better or worse than the placement affinities of the individual sets. The placement score Sₚₗ is defined as follows

$${S}_{pl} ( {C}_{1} ⋃ {C}_{2} ) = \frac{{M}_{pl} ( {C}_{1} ) + {M}_{pl} ( {C}_{2} ) - {M}_{pl} ( {C}_{1} ⋃ {C}_{2} )}{{M}_{pl} ( {C}_{1} ) + {M}_{pl} ( {C}_{2} )} \qquad ( 46 )$$

This metric may be a unitless number that has the value zero when Mₚₗ(C₁)+Mₚₗ(C₂)=Mₚₗ(C₁ ∪ C₂), i.e., there may be no benefit or penalty due to clustering. Sₚₗ(C₁ ∪ C₂) is negative when Mₚₗ(C₁ ∪ C₂)>Mₚₗ(C₁)+Mₚₗ(C₂) (i.e. the placement affinity of the union is worse than the individual clusters), and vice versa. However, unlike the pin-reduction score Sₚᵢₙ from equation 1, it has only very loose lower and upper bounds. This is because Mₚₗ has only a very loose upper bound.

(iii) Final Normalized Coarsening Score

In order to choose which sets of cells C₁ and C₂ to cluster, a coarsening score S_{coursening}(C₁ ∪ C₂) is computed as follows:
S_{coarsening}(C₁ ∪ C₂)=ωₚᵢₙ×Sₚᵢₙ(C₁ ∪ C₂)+ωₚₗ×Sₚₗ(C₁ ∪ C₂) (47)

This is a linear combination of the pin reduction term from equation 1 and the placement affinity term from equation 46. The multipliers ωₚᵢₙ and ωₚₗ are user supplied weights that can be used to tune the relative importance of pin reduction vs. placement affinity. Because the scores have been normalized, and are of approximately the same scale, the default values of these terms are set to be equal ωₚᵢₙ=ωₚₗ, giving both terms approximately equal influence. Additional terms can easily be added to this cost function, for example, a penalty for cluster size (for size balancing), timing, timing slack, placement aspect ratio, and macro area vs. standard cell area ratio.

Note that in some embodiments, the latter two, aspect ratio and macro versus standard cell area, may not be well optimized during coarsening. However, it is the aspect ratio and cell area ratio of the final partition that may be of interest in such embodiments. In particular, their values may not be monotonic during successive clustering phases, and therefore, their values during early clustering phases may not be good predictors for their final values. In one embodiment, a good solution may be characterized by those term weights that increase with each coarsening iteration, or optimize them only during the uncoarsening and refinement phase.

2. Graph Coarsening: Lazy Update Heuristic (LU)

In one embodiment, all of the best-neighbor re-calculations required by BCC can be quite computationally expensive, especially when clusters are large and have many pins and thus many neighbors. This problem may be addressed with a technique referred to as lazy-update (LU). Rather than re-evaluating the PQ records that refer to nₐ and n_{b}, one embodiment simply marks them stale. When a stale record appears at the top of the PQ is it re-evaluated and re-inserted into the PQ. Clearly, if the re-evaluated cost is higher, optimality has not suffered—the record is inserted back into the PQ and the real optimal choice is selected. When the record's cost is lower, the results are different—the stale record is lower in the PQ than it should be, and therefore, does not appear at the top of the PQ when it should. It is noted that in one embodiment there may be an expectation that most of the time the new cost increases as the vertex is forced to choose its next-best neighbor.

D. Initial Partition Generation

Referring back to FIG. 1, step 140 is illustrative of a process of initial partition generation. In one embodiment, step 140 includes generating a simplified netlist responsive to the coarsening stage, and generating an initial partitioning based on a set of design objectives and the simplified netlist. The coarsening phase terminates when some stopping criterion, for example, based on the number of vertices, is reached. Some embodiments of multi-level partitioners terminate coarsening fairly early and then construct the initial partition using an arbitrary non-multilevel recursive bi-partitioning process such as the Fiduccia-Mattheyses (FM) heuristic.

Because the PHG problem begins with a relatively small number of pre-clustered modules, one embodiment adopts a different 2-phase coarsening approach. For example, in the first phase it limits coarsening to the glue logic leaf cells, seeking to cluster them together or assign them to one of the pre-clustered modules. In the second phase it further performs a relatively small number of additional coarsening iterations to directly achieve the initial k-way physical hierarchy partition.

In one embodiment, coarsening may stop at any time when the vertices are between the user-supplied minimum and maximum cell count constraints. After a vertex reaches its minimum cell count it uses the placement-affinity heuristic from pre-clustering to decide whether to continue coarsening. Successive merges are accepted under two conditions: (1) if the new placement affinity is better than the old, or (2) if the user has specified a hard constraint on the number of partitions, that constraint has not yet been met, and all other partitions have also reached their minimum cell count constraints.

E. Graph Uncoarsening and Refinement

Continuing with step 150 in FIG. 1, it is illustrative of a process of graph uncoarsening and refinement. During the uncoarsening and refinement stage the netlist is iteratively de-clustered one level at a time, reversing the clustering process performed during the coarsening stage. At each level the partition solution is projected onto the new uncoarsened graph. In one embodiment, the process executes an FM style k-way partition refinement process on the new graph that moves vertices between partitions until a local cost minimum is reached. As mentioned previously, this iteration between uncoarsening and refinement reflects the multi-level paradigm, and it has been shown to be highly effective because of its ability to optimize wire length at many different scales of granularity simultaneously.

1. Partition Refinement Cost Function

In this section the cost function score used during the uncoarsening and refinement stage of the multilevel partitioning process is discussed. As described above, during each uncoarsening step, an FM style k-way partition refinement process is executed on the new uncoarsened hypergraph in an attempt to improve the quality of the current partitioning.

At each iteration of the refinement an unlocked vertex, e.g., referenced as the base vertex, is selected and moved from one partition to another. In addition, the cost function is updated and the base vertex is locked. This process continues until all vertices have been moved, and then a partitioning is selected from the iteration with the best cost.

As in the clustering score described above, the refinement cost is a multi-variable cost function with two or more terms. The first term is the traditional cost function of the FM algorithm, reflecting the reduction in the global cut set. The second term is a new metric based on a measurement of the mutual affinity of the cells in a virtually-flat placement.

a. Cut Set Reduction

A cut set is defined to be the number of edges that cross between two or more partitions. In step 150 the cut set cost function ƒ_{cut}(Pᵢ) of a k-way physical hierarchy partitioning Pᵢ is defined as the sum of the cardinalities of the cut sets of each partition P_{i,j} ∈ Pᵢ, multiplied by the weighted cost wₑ_{ₖ} of each edge eₖ in the cut set E_{cut}(P_{i,j})
ƒ_{cut}(P_{i,j})=Σwₑ_{ₖ}|eₖ ∈ E_{cut}(P_{i,j}) (48)
ƒ_{cut}(Pᵢ)=Σⱼƒ(P_{i,j}) (49)
The traditional score used during an FM iteration is simply the change in cut set cost resulting from the move of the base vertex v_{base} from partition P_{i,a} to partition P_{i,b}.
ƒ_{cut}(P_{i,b} ∪ v_{base})−ƒ_{cut}(P_{i,a} ∪ v_{base})−ƒ_{cut}(P_{i,b})+ƒ_{cut}(P_{i,a}) (50)

In the PHG system this cut set reduction score is adopted as the first term in the overall partition refinement score, except that it is normalized by dividing by its upper bound, the sum of the weights of all edges in G.

$${S}_{cut} ( {v}_{base} ) = \frac{{f}_{cut} ( {P}_{i , b} ⋃ {v}_{base} ) - {f}_{cut} ( {P}_{i , a} ⋃ {v}_{base} ) - {f}_{cut} ( {P}_{i , b} ) + {f}_{cut} ( {P}_{i , a} )}{\sum {w}_{{e}_{k}} \vert {e}_{k} ∈ E} \qquad ( 51 )$$

This normalization makes the score into a unitless number between zero and one that is more easily combined with the second placement affinity term.
b. Placement Affinity

The placement affinity term, summarized in one embodiment by equation 54, in the partition refinement score is defined similarly to the cut set reduction term. It is a change in the sum of the placement affinities of the partitions P_{i,j} in partitioning Pᵢ when the base cell is moved from partition P_{i,a} to partition P_{i,b}. From equation 45, the mutual placement affinity of a cluster of cells C represented by a vertex v is defined as follows:

$${M}_{pl} ( C ) = \frac{{area ( C )}_{observed}}{{area ( C )}_{ideal}} = \frac{12 ( {σ}_{{C}_{x}} \times {σ}_{{C}_{y}} )}{{\sum }_{i = 1}^{\vert C \vert} area ( {c}_{i} )} \qquad ( 52 )$$

The change in placement affinity resulting from the move of the base vertex v_{base} from partition P_{i,a} to partition P_{i,b} would then be as follows
Mₚₗ(P_{i,b} ∪ v_{base})−Mₚₗ(P_{i,a} ∪ v_{base})−Mₚₗ(P_{i,b})+Mₚₗ(P_{i,a}) (53)

This change in affinity is adopted as the second term in the overall cost function, except that it is normalized by dividing by its upper bound, the total placement affinity of all cells in the original netlist, represented by all vertices in the current hypergraph

$${S}_{pl} ( {v}_{base} ) = \frac{{M}_{pl} ( {P}_{i , b} ⋃ {v}_{base} ) - {M}_{pl} ( {P}_{i , a} ⋃ {v}_{base} ) - {M}_{pl} ( {P}_{i , b} ) + {M}_{pl} ( {P}_{i , a} )}{{M}_{pi} ( V )} \qquad ( 54 )$$

As above, this normalization makes the placement affinity score into a unitless number between zero and one.
c. Final Normalized Refinement Score

In order to choose the base cell v_{base} from the current set of unlocked vertices, a refinement score S_{refinement}(v_{base}) is computed as follows
S_{refinement}(v_{base})=ω_{cut}×S_{cut}(v_{base})+ωₚₗ×Sₚₗ(v_{base}) (55)
This is a linear combination of the cut set reduction term from equation 51 and the placement affinity term from equation 54. The multipliers ω_{cut} and ωₚₗ are user supplied weights that can be used to tune the relative importance of cut set reduction vs. placement affinity. Because the scores have been normalized, and are of approximately the same scale, the default values of these terms are set to be equal ω_{cut}=ωₚₗ, giving both terms approximately equal influence. Further, additional terms can easily be added to this cost function. These additional terms may include, for example, penalty for cluster size (for size balancing), timing, timing slack, placement aspect ratio, and/or macro area versus standard cell area ratio.

It is noted that the latter two terms, aspect ratio and macro versus standard cell area, also may have implications from a physical perspective. When aspect ratios deviate far from unity, soft macros can become difficult to route, suffering high horizontal or vertical routing congestion. Soft macros with a relatively large area devoted to hard macros can be difficult to floorplan, as the macros must be packed with little whitespace, and again are prone to routing congestion problems.

Additional constraints may further be considered in the partitioning and refinement stages. For example, repeated blocks (RBs), sometimes also called multiply instantiated blocks (MIBs) may be used to constrain partitioning. According to one embodiment, if an instance of an RB in the logical hierarchy becomes a partition in the physical hierarchy, then all instances of that RB also become partitions. Other cells (such as small clusters or glue logic cells) may only be merged into an RB partition if identical instances can be merged into all instances of the RB.

In another embodiment, partitioning is constrained by the power domains. A power domain is a set of leaf cells sharing a common power supply. Different power domains may use different voltages to achieve different power/performance tradeoffs. Alternately they may use the same voltage, but with different power gating control circuitry that switches off power to the cells when they are not in use. Splitting a power domain into two partitions may not be desirable because of the extra overhead required to distribute the power supply voltage to each partition, and to duplicate associated level shifting cells and/or power gating logic to each partition. Thus, in one embodiment the power domains are treated as constraints in the partitioning problem. In this embodiment, cells in different power domains are constrained from being clustered together. Alternatively, the cost function can be modified to include a power domain term that would minimize the “power domain cut set” (the number of partition boundaries that split a given domain into different partitions.

In yet another embodiment, partitioning is constrained by the clock domains of the cells. A clock domain is a set of leaf cell latches or flip flops that share a particular clock distribution network. Different clock domains may operate at different clock frequencies or duty cycles, for example, or they may be different versions of a common clock that are gated to switch off the clock to portions of the circuit that are not in use during a particular clock cycle. In some instances, splitting a clock domain into two partitions may be undesirable because of the extra overhead of routing the clock network to each partition, or duplicating the clock gating logic in each partition. Thus, in one embodiment, clock domains may be considered as hard constraint during partitioning and refinement. Alternatively, an additional clock domain term can be added to the cost function that minimizes the “clock domain cut set”.

F. Multi-Phase Refinement

Turning next to the dotted line branch 160 in FIG. 1, it is illustrative of a process of multi-phase refinement. The coarsening, partition generation, and uncoarsening/refinement stages may be referenced as a “V-cycle”. The V-cycle may be repeated more than once in a process known as multi-phase refinement (MPR). After the first V-cycle a restricted coarsening process is used in step 130 which preserves the partitioning found in the previous V-cycle. In restricted coarsening, clusters may only merge with other clusters that belong to the same initial partition. After coarsening the previous' partitioning information is disregarded and a new “initial” partition is generated in step 140. In MPR the uncoarsening process of step 150 in successive V-cycles is identical to that used in the first V-cycle. In one embodiment, all of the steps shown in FIG. 1 may be executed with blocks 130, 140, and 150 being repeated as many times are required for the partitioning process to converge.

G. Alternative Embodiments

As previously described, there may many alternative embodiments for the steps described in FIG. 1. For example, one embodiment performs just the steps of virtually-flat placement 110, pre-clustering 120, and graph coarsening 130. Additional combinations include: steps 110 and 130 (with new cost function); steps 110, 130, and 150 (with new cost function); steps 110, 130, 140, and 150 (with new cost function); steps 110 and 140 (with new cost function); steps 110, 120 and 140 (with new cost function); steps 110 and 150 (with new cost function) and steps 120 and 150. Other combinations are possible as well.

Further Illustrations

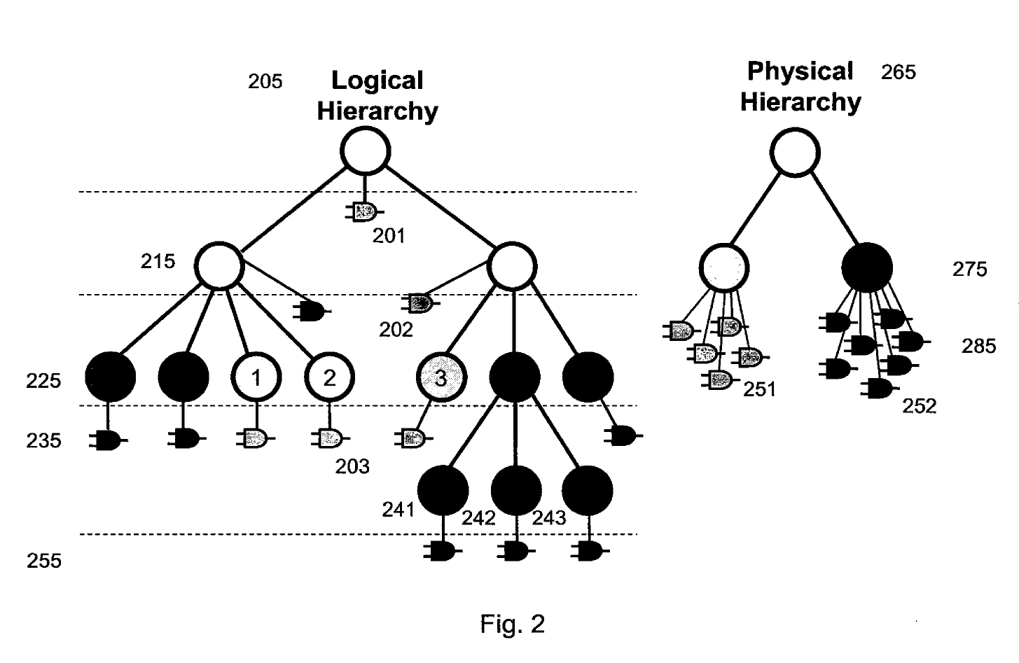

Turning now to FIG. 2, it illustrates embodiments of two example representations of hierarchy within a chip design. A logical hierarchy 205 is shown as described in RTL logic modules. These modules are represented as having multiple levels of submodules 215, 225, 235, and 255. Within each of these levels of logical hierarchy multiple RTL submodules can exist as in the case of submodules 241, 242, and 243.

A physical hierarchy 265 is again represented as having multiple levels of hierarchy as illustrated by submodules 275 and 285. The logical hierarchy has three levels while the physical hierarchy has only one. All cells shaded in grey (and therefore all cells below them in the hierarchy) are grouped together in the physical hierarchy, as are the un-shaded cells.

Note that the leaf cells, such as leaf cells 201, 202, and 203, are not constrained to exist only at the bottom of the logical hierarchy. Any level, including the top level, may contain leaf cells. Leaf cells at intermediate levels of hierarchy are often called glue logic. They may represent small amounts of control logic shared by the blocks below, test logic added for BIST or boundary scan, clock generation or gating logic, etc. In our example we have grouped all leaf cells within the physical hierarchy blocks, such as leaf cells 251 and 252, leaving no glue logic at the top. Although this may be required in a fully abutted floorplan, it generally is optional.

Re-organizing the logical hierarchy into the physical hierarchy can be quite disruptive to the design. Grouping together cells which are siblings of each other, for example, cells 1 and 2 in FIG. 2, may be done using conventional techniques. Modifying the hierarchy to group together non-siblings (for example, cells 1 and 3) may require the creation and deletion of pins in the logical netlist. Such extensive modification may make the logical hierarchy netlist almost un-recognizable to the logic designers, which can be problematic if simulation testbenches or formal verification tools must be run on both netlists. It may, therefore, be desirable for the physical hierarchy generation system to follow the original logical hierarchy as much as possible.

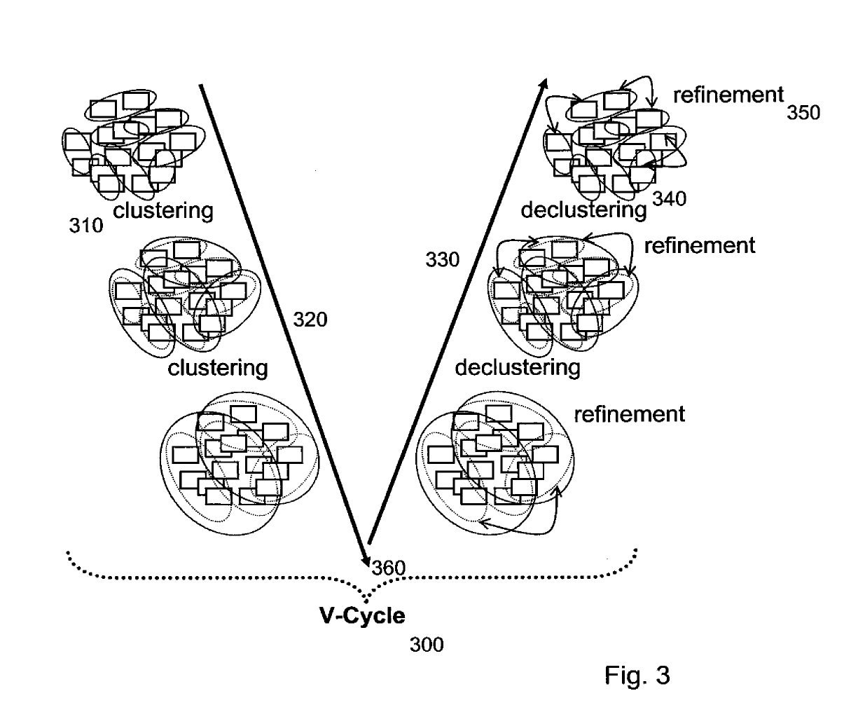

FIG. 3 illustrates a V-cycle 300 through one embodiment of a process of clustering, declustering, and refinement as described in steps 130-150 of FIG. 1. These steps correspond to a multilevel k-way hypergraph partitioning flow. During the coarsening phase 320, sets of connected vertices are successively clustered 310 together into coarser and coarser graphs. The coarsening is stopped 360 when a criteria, typically related to the number of vertices, is attained. The graph is then un-coarsened 330 and refined. This is accomplished by iteratively declustering 340 one level at a time. The refinement 350 is then accomplished by moving vertices between clusters in an effort to minimize a cost function. Step 160 corresponds to proceeding through one or more additional V cycles.

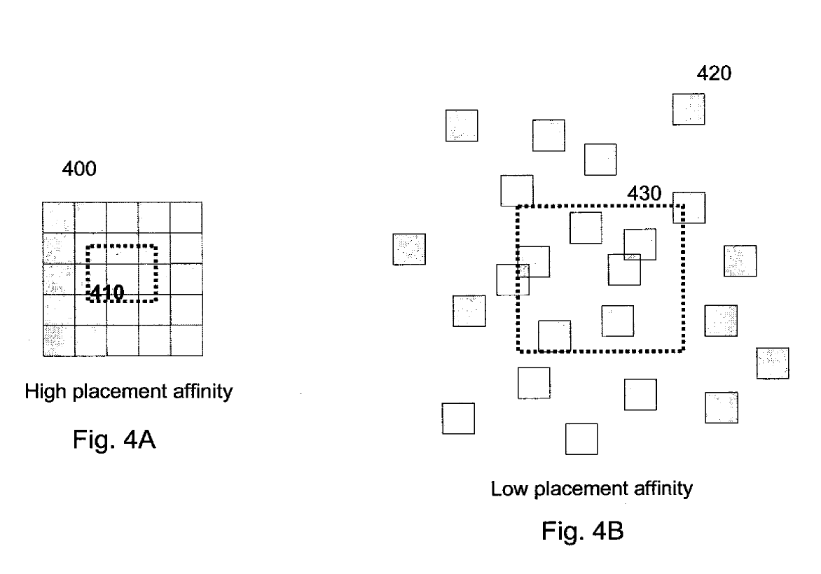

Next, FIGS. 4A-B illustrate examples of cells with a high degree of affinity and cells with a low degree of affinity. These figures help illustrate the placement affinity metric discussions provided earlier. FIG. 4A shows a cluster of cells 400 tightly packed together with a resulting high degree of affinity R_{σ}. Given a set of cells C={c₁, c₂, . . . , cₙ}, and assuming that all cells are placed in the smallest possible rectangular bounding box such that they are non-overlapping, that box will have an area equal to the sum of the areas of the constituent cells divided by 12. FIG. 4A illustrates this example. This bounding box 410 can be viewed as the ideal bounding box, e.g., the bounding box of the best possible placement of the cells, and a lower bound on the placement affinity of the cells. FIG. 4B illustrates a cluster of cells 420 in a much sparser arrangement. The resulting affinity measure R_{σ} will be considerably lower. As a result, bounding box 430 is much larger.

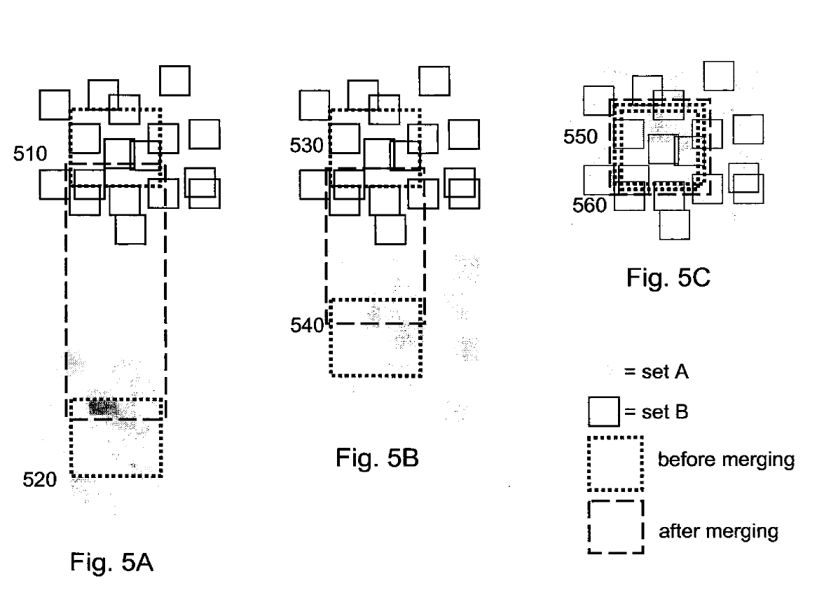

Referring next to FIGS. 5A-C, these illustrate affinity examples before and after cluster merging. In FIG. 5A two cell clusters 510 and 520 that are merged have high individual placement affinity, but are placed relatively far apart. In this case Mₚₗ(C₁ ∪ C₂) will be less than Mₚₗ(C₁)+Mₚₗ(C₂) and Sₚₗ(C₁ ∪ C₂) will be negative indicating a bad clustering choice. In FIG. 5B the two high-affinity clusters 530 and 540 are adjacent to one another and Sₚₗ(C₁ ∪ C₂) will be zero. In FIG. 5C the clusters 550 and 560 are overlapping and Sₚₗ(C₁ ∪ C₂) will be positive because the merged cluster has better placement affinity than the two clusters before merging.

The order in which the steps of the methods are performed is purely illustrative in nature. The steps can be performed in any order or in parallel, unless otherwise indicated by the present disclosure. The methods described herein may be performed in hardware, firmware, software, or any combination thereof operating on a single computer or multiple computers of any type. Software (or computer program product) embodying the described systems and methods may comprise computer instructions in any form (e.g., source code, object code, interpreted code, etc.) stored in any computer-readable storage medium (e.g., a ROM, a RAM, a solid state media, a magnetic media, a compact disc, a DVD, etc.). The instructions are executable by a processor (or processing system). In addition, the software may be in the form of an electrical data signal embodied in a carrier wave propagating on a conductive medium or in the form of light pulses that propagate through an optical fiber.

While particular embodiments have been shown and described, it will be apparent to those skilled in the art that changes and modifications may be made without departing from this disclosure in its broader aspect and, therefore, the appended claims are to encompass within their scope all such changes and modifications, as fall within the true spirit of this disclosure.

In the above description, for purposes of explanation, numerous specific details are set forth in order to provide a thorough understanding of the disclosure. It will be apparent, however, to one skilled in the art that the described embodiments can be practiced without these specific details. In other instances, structures and devices are shown in diagram form in order to avoid obscuring the embodiments.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It will be understood by those skilled in the relevant art that the above-described implementations are merely exemplary, and many changes can be made without departing from the true spirit and scope of the disclosure. Therefore, it is intended by the appended claims to cover all such changes and modifications that come within the true spirit and scope of this disclosure.

What is claimed is:

1. An automated method for physical hierarchy generation, the method comprising:
receiving a virtually-flat placement of a logically hierarchical design having a plurality of cells;
calculating a placement affinity metric in response to receiving the virtually-flat placement; and
coarsening the plurality of cells by clustering cells in the logically hierarchical design using the calculated placement affinity metric.

2. The method of claim 1, further comprising pre-clustering the plurality of cells using at least one of logical relationships between the plurality of cells in the logically hierarchical design and the placement affinity metric.

3. The method of claim 1, wherein the virtually-flat placement comprises:
a set of approximate locations of cells, wherein the set of approximate locations are selected to satisfy a predetermined set of design objectives.

4. The method of claim 3, wherein the set of design objectives comprises at least one of wire length, routing congestion, and critical path delay.

5. The method of claim 1, wherein the placement affinity metric, Mₚₗ(C), is determined by a first function that quantifies relative proximity of cells to each other in a cluster as a result of forming the cluster.

6. The method of claim 5, wherein the first function is
$${M}_{pl} ( C ) = \frac{{area ( C )}_{observed}}{{area ( C )}_{ideal}} = \frac{12 ( {σ}_{{C}_{x}} \times {σ}_{{C}_{y}} )}{{\sum }_{i = 1}^{\vert C \vert} area ( {c}_{i} )}$$
wherein C is a set of one or more cells, cᵢ is an element of the set C, σ_{Cx} is a standard deviation in an x direction and σ_{Cy} is a standard deviation in a y direction of placement locations of sub-cells cᵢ.

7. The method of claim 1, wherein coarsening comprises iteratively merging smaller clusters of cells into larger clusters of cells.

8. The method of claim 1, wherein coarsening comprises using a best choice clustering heuristic, the best choice clustering heuristic comprising computing a clustering score, wherein the clustering score is based at least in part on a pin reduction score and a placement affinity score.

9. The method of claim 8, wherein the pin reduction score, Sₚₗ, is determined by
$${S}_{pin} ( a ⋃ b ) = \frac{{W}_{{E}_{a}} + {W}_{{E}_{b}} - {W}_{{E}_{a ⋃ b}}}{{W}_{{E}_{a}} + {W}_{{E}_{b}}}$$
wherein W_{Ea} is a weight of edges on vertex a, W_{Eb} is a weight of edges on vertex b, and W_{Eaub} is a weight of edges on vertex a ∪ b, wherein vertex a ∪ b is formed by merging vertex a and vertex b.

10. The method of claim 8, wherein the placement affinity score, Sₚₗ, is determined by:
$${S}_{pl} ( {C}_{1} ⋃ {C}_{2} ) = \frac{{M}_{pl} ( {C}_{1} ) + {M}_{pl} ( {C}_{2} ) - {M}_{pl} ( {C}_{1} ⋃ {C}_{2} )}{{M}_{pl} ( {C}_{1} ) + {M}_{pl} ( {C}_{2} )}$$
wherein Mₚₗ is a placement affinity metric, C₁ is a first set of one or more cells, and C₂ is a second set of one or more cells.

11. The method of claim 8, wherein the clustering score is a linear combination of the pin reduction and the placement affinity.

12. The method of claim 1, wherein coarsening the plurality of cells further comprises performing a lazy update clustering heuristic.

13. The method of claim 1, further comprising:
generating a simplified netlist responsive to coarsening the plurality of cells; and
generating an initial partitioning based on a set of design objectives and the simplified netlist.

14. The method of claim 13, further comprising refining the initial partitioning based on the placement affinity metric.

15. The method of claim 13, further comprising repeating one or more of the steps of coarsening the virtually-flat placement, generating the initial partitioning, and refining the initial partitioning.

16. An automated method for physical hierarchy generation, the method comprising:
receiving a virtually-flat placement of a logically hierarchical design comprising a plurality of cells clustered into initial partitions;
calculating a placement affinity metric; and
refining the initial partitions by moving at least one cluster between the initial partitions, wherein the at least one cluster is selected using the placement affinity metric.

17. The method of claim 16, further comprising uncoarsening clusters of cells in the initial partitions by de-clustering one or more cells previously clustered in a coarsening stage.

18. The method of claim 17, wherein the refining the initial partitions further comprises:
moving one or more de-clustered cells from a first partition to a second partition to generate a new partitioning; and
updating a refinement score responsive to moving the one or more de-clustered cells, the refinement score based at least in part on a measurement of mutual affinity of the one or more cells in the new partitioning.

19. The method of claim 18 wherein the refinement score is a linear combination of a cut set reduction score and a placement affinity score.

20. The method of claim 16, further comprising creating physical partitions based on the refined initial partitions.

21. The method of claim 20, wherein creating the physical partitions comprises partitioning all instances of a repeated block in separate physical partitions.

22. The method of claim 21, wherein the instances of the repeated block all have identical glue logic.

23. The method of claim 20, wherein creating the physical partitions comprises minimizing the number of different power domains in each physical partition.

24. The method of claim 20, wherein each physical partition has cells from only one power domain.

25. The method of claim 20, wherein creating the physical partitions comprises minimizing the number of different clock domains in each physical partition.

26. The method of claim 20, wherein each physical partition has cells from only one clock domain.

27. The method of claim 16, wherein refining the initial partitions comprises a Fiduccia-Mattheyses style k-way partition refinement process.

28. A computer readable storage medium for physical hierarchy generation, the computer readable storage medium storing instructions executable by a processing system, the instructions when executed cause the processing system to:
receive a virtually-flat placement of a logically hierarchical design having a plurality of cells;
calculate a placement affinity metric in response to receiving the virtually-flat placement; and
coarsen the plurality of cells by clustering cells in the logically hierarchical design using the calculated placement affinity metric.

29. The computer readable storage medium of claim 28, further comprising stored instructions that when executed cause the processing system to pre-cluster the plurality of cells using at least one of a set of logical relationships between the plurality of cells in the logically hierarchical design and the placement affinity metric.

30. The computer readable storage medium of claim 28, wherein the instructions to coarsen further comprise instructions that when executed cause the processing system to iteratively merge smaller clusters of cells into larger clusters of cells.

31. The computer readable storage medium of claim 28, wherein the instructions to coarsen further comprise instructions that when executed cause the processing system to use a best choice clustering heuristic, the best choice clustering heuristic comprising instructions that when executed cause the processing system to compute a clustering score, wherein the clustering score is based at least in part on a pin reduction score and a placement affinity score.

32. The computer readable storage medium of claim 28, further comprising stored instructions that when executed further cause the processing system to:
generate a simplified netlist responsive to coarsening the plurality of cells; and
generate an initial partitioning based on a set of design objectives and the simplified netlist.

33. The computer readable storage medium of claim 32, further comprising stored instructions that when executed further cause the processing system to refine the initial partitioning using the placement affinity metric.

34. The computer readable storage medium of claim 33, further comprising stored instructions that when executed cause the processing system to repeat instructions that cause it to coarsen the virtually-flat placement, generate the initial partitioning, and refine the initial partitioning.

35. A computer readable storage medium for physical hierarchy generation, the computer readable storage medium storing instructions executable by a processing system, the instructions when executed cause the processing system to:
receive a virtually-flat placement of a logically hierarchical design comprising a plurality of cells clustered into initial partitions;
calculate a placement affinity metric; and
refine the initial partitions by moving at least one cluster between the initial partitions, wherein the at least one cluster is selected using the placement affinity metric.

36. The computer readable storage medium of claim 35, the instructions when executed further cause the processing system to uncoarsen clusters of cells in the initial partitions by de-clustering one or more cells previously clustered in a coarsening stage.

37. The computer readable storage medium of claim 36, wherein refining the initial partitions further comprises instructions that when executed cause the processing system to:
move one or more de-clustered cells from a first partition to a second partition to generate a new partitioning; and
update a refinement score responsive to moving the one or more de-clustered cells, the refinement score based at least in part on a measurement of mutual affinity of the one or more cells in the new partitioning.
